(19) United States
(12) Patent Application Publication
(10) Pub. No.: US 2013/0319938 A1
(43) Pub. Date: Dec. 5, 2013

(54) Method for Treating Water Within a Sequencing Batch Reactor, Including an In-Line Measurement of the Nitrite Concentration

(71) Applicants: Romain Lemaire, Paris (FR); Julien Chauzy, Antony (FR); Frédéric Veuillet, Maisons Alfort (FR)

(72) Inventors: Romain Lemaire, Paris (FR); Julien Chauzy, Antony (FR); Frédéric Veuillet, Maisons Alfort (FR)

(73) Assignee: Veolia Water Solutions & Technologies Support, Saint-Maurice Cedex (FR)

(21) Appl. No.: 13/879,818

(22) PCT Filed: Oct. 18, 2011
(86) PCT No.: PCT/EP2011/068196

§ 371 Date: Aug. 23, 2013

(30) Foreign Application Priority Data
Oct. 18, 2010 (FR) 1058492

(51) Int. Cl. C02F 3/30

(52) U.S. Cl. CPC C02F 3/302
USPC 210/614

(57) ABSTRACT

A method for treating water laden with nitrogen in the form of ammonium within a sequencing batch reactor, said method including: a first step of feeding said water into said sequencing batch reactor; an aerated nitritation step); an anoxic denitritation step; and a step of extracting treated water from said reactor. The method further includes an in-line measurement of the nitrite concentration of said water in said reactor, a step of measuring the pH of said water contained in said reactor, a step of determining information that is representative of the nitrous-acid (HNO₂) concentration of said water contained in said reactor on the basis of said in-line measurement of the nitrite concentration and said pH measurement, and a step of controlling the duration of said aerated nitritation process in accordance with said nitrous-acid concentration.

### 1. FIELD OF THE INVENTION

The field of the invention is that of the treatment of water charged with nitrogen in the form of ammonium. The invention can be applied especially in the treatment of industrial or municipal effluents such as anaerobic digester supernates, effluents from the treatment of sludges by wet oxidation, gas treatment condensates, condensates from the treatment of wastewater sludge, discharge lixiviates, slaughterhouse effluents, liquid pig manure or any other type of effluent charged with nitrogen in ammonium form.

More specifically, the invention pertains to a water treatment method implementing a sequencing batch reactor (SBR) within which there are successively implemented especially steps of aerated and anoxic biological treatment

### 2. PRIOR ART

Biological water treatment methods are commonly used to reduce the nitrogen pollution content of water.

These biological methods include a method of nitrification-denitrification which can be implemented continuously or sequentially.

Such a method consists of the introduction of a water to be treated into a biological reactor within which aerated and anoxic phases are implemented.

During the aerated phases, the injection of oxygen (in the form of air or pure oxygen for example) into the reactor promotes the growth of an autotrophic nitrifying biomass enabling the conversion of nitrogen in ammonium form (NH₄⁺) into nitrates (NO₃⁻). This biomass is in fact constituted by a biomass that converts nitrogen in ammonium form (NH₄⁺) into nitrites (NO₂⁻) and is called an AOB (“ammonia oxidizing bacteria”) biomass and a biomass that converts the nitrites (NO₂⁻) into nitrates (NO₃⁻) and is called an NOB (nitrite oxidizing bacteria”) biomass.

During the anoxic phases, stopping the aeration of the reactor promotes the growth of a denitrifying biomass which reduces the nitrates into molecular nitrogen gas (diazote) N₂ in passing through the nitrite stage. This denitrifying biomass is heterotrophic in nature, i.e. it can grow only in the presence of a source of organic carbon.

This method of reducing nitrogen pollution by nitrification-denitrification is shown schematically in FIG. 1.

A biological treatment method of this kind is particularly efficient because its implementation leads to a non-negligible reduction of the nitrogen pollution content of water. However, it has some drawbacks. In particular, its implementation requires the injection into the reactor of a relatively large quantity of oxygen to ensure the conversion of the ammonium into nitrates. Furthermore, most of the water to be treated has an organic pollution content (BOD or Biochemical Oxygen Demand) that is far too low to enable the satisfactory reduction of nitrogen pollution by nitrification-denitrification. It is thus often necessary to inject carbon into the reactor in the form of reagents (for example an easily biodegradable carbonaceous substrate) so that the heterotrophic type bacteria can ensure the elimination of the nitrates in satisfactory quantities.

Such a method of treatment by nitrification-denitrification is thus relatively costly to implement because of the fairly large consumption of oxygen and carbon reagent that it entails.

In order to at least partially mitigate these drawbacks, a method has been developed aimed at reducing pollution in ammonium form by minimizing the formation of nitrates. This method, known as nitritation-denitritation, also called the “nitrate shunt” method, consists of the introduction of water to be treated into a sequencing batch reactor within which there are alternately implemented aerated phases and anoxic phases in operational conditions providing selective pressure for the growth of AOB bacteria to the detriment of the NOB bacteria. These operational conditions may be high concentration of ammonium (NH₄⁺), low concentration of dissolved oxygen during the aerated phases, temperature above 28° C., a low age of sludge or several operational conditions combined.

During the aerated phases, the injection of oxygen into the reactor enables the growth of AOB type bacteria which act on the ammonia nitrogen (NH₄⁺) to form nitrites (NO₂⁻). The use of a sequencing batch reactor gives high ammonium concentrations after each sequence of supplying water to be treated into the reactor. Since the NOB bacteria are more inhibited by high concentrations of aqueous ammonia in chemical equilibrium with ammonium in aqueous phase than the AOB bacteria, their growth is limited. Besides, the oxygen is injected in such a way as to preferably maintain a low concentration of dissolved oxygen in the reactor, in order to promote the growth of AOB bacteria to the detriment of NOB bacteria because of a greater affinity for oxygen on the part of the AOB bacteria. The production of nitrates from nitrites by the NOB biomass is thus limited.

During anoxic phases, the role of the heterotrophic biomass is essentially that of converting the nitrites into molecular nitrogen, the nitrate content being low. This heterotrophic biomass competes with the NOB biomass for the consumption of nitrites and contributes to limiting the growth of the NOB biomass.

This method of reducing nitrogen pollution by “nitrate shunt” is shown schematically in FIG. 2.

The implementation of such a nitritation-denitritation method, as compared with a classic nitrification-denitrification method described in FIG. 1, reduces oxygen consumption by about 25% and carbon reagent consumption by about 40%. It thus reduces the nitrogen pollution of water satisfactorily and more economically.

There is another biological method known in the prior art called the “nitritation-deammonification” method. This method further reduces the cost inherent in the treatment of the nitrogen pollution of water.

In such a method, water to be treated is introduced into a sequencing batch reactor within which aerated phases and anoxic phases are implemented, alternately in minimizing the formation of nitrates by selective operational conditions and implementing a specific biomass known as an “anammox” biomass.

During the aerated phases, the implementation of the same operational conditions as those described here above for the “nitrate shunt” method enables the selection of AOB bacteria to the detriment of the NOB bacteria and minimizes the production of nitrates from nitrites by the NOB biomass.

During the anoxic phases, anammox type bacteria grow and act on the ammonium ions and on the nitrites to form molecular nitrogen gas (N₂) as well as a small quantity of nitrates without consuming organic carbon since these are autotrophic bacteria, unlike the heterotrophic biomass responsible for the denitritation step in the “nitrate shunt” method.

When the denitritation step, consisting of the degradation of nitrites into molecular nitrogen gas (N₂), involves anammox type bacteria, this step called a denitritation step is more specifically called deammonification.

The implementation of such a “nitritation-deammonification” method, as compared with a classic “nitrification-denitrification” method reduces oxygen consumption by about 60% and carbon reagent consumption by about 90%. It thus reduces the nitrogen pollution of water satisfactorily and even more economically.

This method for reducing nitrogen pollution by “nitritation-deammonification” is shown schematically in FIG. 3.

3. DRAWBACKS OF THE PRIOR ART

While the implementation of methods for reducing nitrogen pollution by nitritation-denitritation of the “nitrate shunt” or nitritation-deammonification type have the advantages of reducing the consumption in oxygen and carbon reagents as compared with the classic nitrification-denitrification methods, it is not free of drawbacks.

In particular, it has been observed that the implementation of nitritation-denitritation methods by “nitrate shunt” or by “nitritation-deammonification” cause the discharge into the atmosphere of nitrogen protoxide (N₂O) also called nitrous oxide.

Nitrogen protoxide is a gas with a powerful greenhouse effect. It is especially 300 times more powerful than carbon dioxide. Beyond its contribution to the heating of the atmosphere, nitrogen protoxide also takes part in the destruction of the ozone layer. The discharge into the atmosphere of nitrogen protoxide exerts a negative impact on the environment.

In a context where the importance given to environmental constraints and to the preservation of the environment is constantly increasing, the discharge of nitrogen protoxide is a brake on the use of methods of nitritation-denitritation by nitrate shunt or nitritation-deammonification even when it brings the advantages of reducing consumption in oxygen and carbon reagents.

Many studies have been conducted in order to identify the origins of such discharges of nitrogen protoxide.

Most of these studies have led those skilled in the art to admit the fact that AOB type bacteria are the cause of the discharge of nitrogen protoxide during the nitritation steps when the oxygen concentration in the reactor is low and when the nitrite concentration therein is great. In these conditions, the AOB bacteria indeed consume a part of the nitrates that they generate to produce nitrogen monoxide. They consume this nitrogen monoxide to produce nitrogen protoxide. However, it has not yet been demonstrated that these AOB bacteria can consume nitrogen protoxide to produce nitrogen oxide which would mean that large quantities of nitrogen protoxide would then be discharged into the atmosphere.

Shiskowski & Mavinic teach that, in the presence of nitrites in the reactor, a drop in the pH, i.e. a rise in the nitrous acid (HNO₂) concentration in the reactor, is accompanied by an increase in the production of nitrogen protoxide (Shiskowski M., Mavinic S. 2006, “The influence of nitrite and pH (nitrous acid) on aerobic-phase, autotrophic N₂O generation in a wastewater treatment bioreactor”, J. Environ, Eng. Sci. 5: 273-283). The authors therefore have put forward the hypothesis according to which the pH of the content of the reactor as well as its concentration of nitrites could have importance in the production of nitrogen protoxide by AOB bacteria in conditions of low aeration.

In a more recent study, Kampschreur and al however contradict this hypothesis by indicating that, in the presence of nitrites in the reactor, a drop in the pH, i.e. a rise in the concentration of nitrous acid (HNO₂) in the reactor has no effect on the production of nitrogen protoxide (Marlies J. Kampschreur, Wouter R. L. van der Star, Hubert A. Wielders, Jan Willem Mulder, Mike S. M. Jetten, Mark C. M. van Loosdrecht, 2008, “Dynamics of nitric oxide and nitrous oxide emission during full-scale reject water treatment”, Water research. 42: 812-826). On the contrary, they have observed a drop in the production of nitrogen protoxide whereas the pH in the reactor diminishes during the aerated phase.

Yang and al have subsequently indicated that the production of nitrogen protoxide could be reduced by limiting the ammonia and nitrites concentration in the reactor or by promoting anoxic denitrification by injecting carbon from an external source into the reactor (Qing Yang, Xiuhong Liu, Chengyao Peng, Shuying Wang, Hongwei Sun, Yonhzhen Peng, 2009, “N₂O production during nitrogen removal via nitrite from domestic wastewater: main sources and control method”, Environ. Sci. Technol. 43: 9400-9406).

More recently, Foley and al concluded their study by indicating that the production of nitrogen protoxide is generally linked to a major concentration of nitrites in the bioreactor but that the mechanisms causing the formation of nitrites and nitrogen protoxide are numerous and very complex (Jeffrey Foley, David de Haas, Zhiguo Yuan, Paul Lant, 2010, “Nitrous oxide generation in full-scale biological nutrient removal wastewater treatment plants”, Water research. 44: 831-844).

These scientific publications, some of whose teachings contradict one another, are unanimous in stating that the methods for treating water by nitritation-denitritation have the drawback of giving rise to nitrogen protoxide, the production mechanisms of which are complex and not yet mastered.

In such a context, those skilled in the art of methods for treating water by nitritation-denitritation were incited either to avoid methods of treatment by nitritation-denitritation in order to find alternative solutions that do not produce nitrogen protoxide or to wait for the scientific community to arrive at a uniform way of describing the mechanisms responsible for the production of nitrogen protoxide during the implementation of such methods.

However, contrary to the set assumptions of those skilled in the art, the inventors have taken the imitative of developing a technique for treating water by nitritation-denitritation, this technique enabling the reduction of the consumption in oxygen and carbonaceous substrate, the implementation of which would cause no discharge or at least little discharge of nitrogen protoxide.

### 4. GOALS OF THE INVENTION

The invention is aimed especially at overcoming these drawbacks of the prior art and improving the performance of the “nitrate shunt” and “nitritation-deammonification” type treatment methods, each comprising a nitrate-forming (nitritation) step and a nitrite-degrading (denitritation) step.

In particular, it is a goal of the invention, in at least one embodiment, to provide a technique of this kind that enables improved mastery over the biological processes implemented in water treatment by nitritation-denitritation.

More specifically, it is a goal of the invention, in at least one embodiment, to provide a technique of this kind, the implementation of which does not cause any discharge of nitrogen protoxide or at least causes little discharge of oxygen protoxide as compared with the techniques of the prior art.

It is yet another goal of the invention, in at least one embodiment, to provide a technique of this kind that is more economical to implement than the prior-art techniques

### 5. SUMMARY OF THE INVENTION

These goals as well as others that shall appear here below are achieved according to the invention by means of a method for treating water charged with nitrogen in ammonium form within a sequencing batch reactor, said method comprising at least:
a first step (i) for feeding said sequencing batch reactor with said water;
an aerated nitritation step (ii);
an anoxic denitritation step (iii);
a step (iv) for extracting treated water from said reactor
   said method furthermore comprising an in-line measurement of the concentration of nitrites in said water present in said reactor, a measurement of the pH of said water present in said reactor, a step for determining a piece of information representing the concentration of nitrous acid (HNO₂) in said water contained in said reactor as a function of said in-line measurement of the concentration of nitrites and of said measurement of the pH, and a step for monitoring the duration of said aerated step (ii) of nitritation according to said concentration of nitrous acid.

Thus, the invention relies on a wholly innovative approach which consists in implementing, in the method for treating water by nitritation-denitritation, an in-line measurement of the concentration of nitrites and of the pH of the water present in the sequencing batch reactor within which the reactions of nitritation and denitritation take place and a deducing of the concentration of nitrous acid from this measurement of the concentration of nitrites and from the measurement of the pH with the aim of more efficiently mastering the biological processes involved in such a treatment and especially the production of nitrogen protoxide inherent in the implementation of a method for the treatment of effluent by nitritation-denitritation.

Beyond a certain concentration of nitrous acid in the reactor during the aerated phases, a non-negligible production of nitrogen protoxide is observed. Knowledge of the concentration of nitrites and pH of the water present in the reactor makes it possible to determine its concentration of nitrous acid. The duration of the aerated nitritation phase is monitored according to the invention as a function of the concentration of nitrous acid so that the formation of nitrogen protoxide can be avoided or at least greatly reduced.

The inventors have carried out trials to check whether or not a high concentration of nitrous acid in the reactor causes the production of nitrogen protoxide in a context where Shiskowski & Mavinic, and then Kampschreur and al have divergent opinions on this issue.

The inventors have observed that the production of nitrogen protoxide is not linked to a high nitrites concentration nitrites in the reactor but rather to a high nitrous acid concentration, validating the information given by Shiskowski & Mavinic which nevertheless has been recently contradicted by Kampschreur and al.

This phenomenon is illustrated in FIG. 4 which shows a graph representing the variations in pH, O₂, NO₂, HNO₂ concentrations and N₂O emissions in a reactor within which a method has been implemented for treating water by nitritation-denitritation. The study of this graph shows that peaks of production of nitrogen protoxide coincide with peaks of nitrous acid concentration whereas no peak of production of nitrogen protoxide is observed when the nitrous acid concentration is low even though the nitrites concentration is high. This confirms that the production of nitrogen protoxide during the aerated phases occurs when the nitrous acid concentration in the reactor is high.

Starting from such an observation, those skilled in the art seeking to reduce the production of nitrogen protoxide inherent in the implementation of a method for treating effluent by nitritation-denitritation would have sought to increase the pH within the reactor. This could be obtained by injecting an alkalinizing reagent such as sodium hydroxide into the reactor.

Such a practice can effectively enable an increase in the pH in the reactor and consequently enable the HNO₂ concentration and, therefore, the production of nitrogen protoxide to be reduced in a simple way. However, the injection of alkalinizing reagent is a non-negligible cost item and also has an impact on the environment (from the carbon footprint of the production and transporting of alkalinizing reagent). This practice would therefore reduce the utility of implementing a technique for treating water by nitritation-denitritation, the benefit of which is precisely that of reducing the cost related to the injection of air and carbon reagent into the reactor.

The inventors then sought another solution to prevent or at least to greatly limit the production of nitrogen protoxide during a nitritation-denitritation type of treatment.

In this context, the inventors were led to implement the invention which, as already explained here above, consists in determining the nitrous acid concentration in the reactor from the measurement of the nitrites concentration and the measurement of pH in the reactor and then monitoring the duration of the nitritation phase, in other words the aeration of the reactor, as a function of the nitrous acid concentration.

Knowledge of the nitrous acid concentration in the reactor makes it possible to efficiently control the aeration of the reactor in such a way that the implementing of the method is optimized and the production of nitrogen protoxide is controlled.

The nitrites concentration is measured in line, i.e. it is done directly on the production site and not in a laboratory after taking samples.

This measurement can be done directly, i.e. by means of a probe directly measuring the concentration of nitrite ions in solution or indirectly, i.e. for example by means of a probe measuring the oxidized forms of nitrogen in solution (also called NOₓ) as well as the nitrate ions and, from this measurement, deducing the nitrites concentration by computation.

As understood in the invention, denitritation is a step during which nitrites are degraded into molecular nitrogen gas. This degradation may involve heterotrophic and/or anammox type bacteria. When the denitritation step involves anammox type bacteria, it is more specifically called “deammonification”.

The feeding and aeration steps can be implemented concomitantly in order to reduce the duration of the treatment.

A method according to the invention may comprise a unique cycle comprising a feeding of the reactor with all the water to be treated, a nitritation, a denitritation and an extraction of the treated water. According to another approach, a method according to the invention may comprise a plurality of sub-cycles each comprising a feeding of the reactor with a portion only of the water to be treated, a nitritation and a denitritation. Several sub-cycles are then successively implemented until the entire volume of water to be treated has been introduced into and treated in the reactor. The treated water can then be extracted from the reactor. A method according to the invention comprises at least one step of feeding, one aerated step of nitritation and one anoxic denitritation step, these steps being not necessarily implemented in this order.

According to an advantageous characteristic, such a method comprises an in-line measurement of the concentration of ammonium ions in said water present in said reactor and a step for monitoring said first step (i) for feeding said reactor, said step for monitoring said first step (i) for feeding comprising the following steps:
computing the sum of said concentration of nitrites and said concentration of ammonium;
comparing said sum with a first predetermined threshold value S1;
comparing said concentration of nitrous acid with a second predetermined threshold value S2;
verifying the level of water in said reactor;
stopping said first step (i) for feeding as soon as said sum is higher than a first threshold value S1 or said concentration of nitrous acid becomes higher than said second threshold value S2 or said high level of said reactor is reached.

Knowledge of the concentration of nitrites and nitrous acid in the reactor makes it possible indeed to efficiently monitor the feeding of water to the reactor so that the implementation of the method is optimized and the production of nitrogen protoxide is fully controlled.

During the feeding itself of the reactor, it can happen that the nitrous acid concentration in the reactor reaches a value such that the production of nitrogen protoxide is favored.

Besides, it has been observed that a high ammonium concentration within the reactor necessarily gives rise to a high nitrites concentration within the reactor. This is because AOB-type bacteria convert the ammonium into nitrites.

In addition, it has been observed that, when the concentration of nitrites within the reactor is excessively great, the AOB-type biomass involved in the nitritation is inhibited by the nitrous acid (HNO₂) which is in chemical equilibrium with the nitrites in aqueous phase.

Thus, by knowing the nitrites and nitrous acid concentration within the reactor, it is possible to stop the feeding of the reactor with ammonium-charged water so that the nitritation is not inhibited, the cleansing performance of the method is not affected and the production of nitrogen protoxide is fully controlled.

According to an advantageous characteristic, said step for monitoring the duration of said aerated nitritation step (ii) comprises the following steps:
comparing said concentration of nitrous acid with a second predetermined threshold value S2;
stopping said aerated nitritation step (ii) as soon as said nitrous acid concentration becomes higher than said predetermined threshold value S2.

The inventors have noted that an excessive nitrous acid concentration favors the production of nitrogen protoxide.

The inventors have also noted that, when the nitrous acid concentration in the reactor becomes great during the step for aerating the reactor, the AOB type biomass involved in the nitritation is inhibited. By knowing the nitrites concentration and the pH in the reactor, it is possible to determine the nitrous acid concentration and stop the aeration of the reactor and initiate an anoxic phase as soon as its value becomes such that it would inhibit the AOB type biomass. The nitrites produced will then be degraded into molecular nitrogen gas because of the activity of the heterotrophic bacteria or anammox bacteria during said anoxic phase.

The control of the aeration according to the invention then both prevents the production of nitrogen protoxide and inhibits the AOB type biomass.

According to one advantageous character, such a method comprises a step for monitoring the duration of said anoxic denitritation step (iii), said step for monitoring the duration of said anoxic denitritation step (iii) comprising the following steps:
comparing said concentration of nitrites with a third predetermined threshold value S3;
stopping said anoxic denitritation step (iii) as soon as said nitrites concentration is lower than said third predetermined threshold value S3.

Knowing the nitrites concentration in the reactor enables efficient monitoring of the duration of the anoxic phase so that the implementation of the method is optimized.

The inventors have indeed noted that, when the nitrites concentration within the reactor becomes excessively low, the kinetics of the denitritation reaction become slower. It can therefore be preferable to stop the anoxic phase in order to always have the highest possible kinetics of nitrite consumption. Thus, as soon as the nitrites concentration in the reactor reaches a predetermined low threshold, the anoxic step has to be stopped and the next step can start. The inventors have observed that the fact of terminating the anoxic phase before the nitrites concentration is zero improves the cleansing performance of the method by maximizing the kinetics of nitrite consumption during the anoxic phase.

According to a first embodiment, said anoxic denitritation step comprises a step for placing said water in contact with heterotrophic bacteria.

The method according to the invention then works in a “nitrate shunt” configuration: the ammonium is converted into nitrites by AOB bacteria and then the nitrites are converted into molecular nitrogen gas by heterotrophic bacteria.

In this case a first variant of such a first embodiment provides that a method according to the invention will comprise an in-line measurement of the concentration of ammonium ions in said water present in said reactor and a step for monitoring said first step (i) for feeding said reactor, said step for monitoring said first step (i) for feeding comprising the following steps:
comparing said concentration of ammonium ions with a fourth predetermined threshold value S4;
verifying the level of water in said reactor;
stopping said first feeding step (i) as soon as said concentration of ammonium ions is higher than said fourth threshold value S4 or as soon as the high level of said reactor is reached.

This first variant is implemented when the effluent treated contains biodegradable COD, the quantity or quality of which is sufficient to at least partially act as a carbonaceous substrate needed for carrying out the denitritation. Consequently, this first step for feeding is without aeration so that the anoxic denitritation phase can be initiated and thus reduce the injections of additional carbon reagent into the reactor and therefore reduce the cost of implementing the method.

According to a second variant of the first embodiment or of its first variant, said anoxic denitritation step comprises a step for injecting carbon into said reactor, said method furthermore comprising a step for monitoring said step for injecting carbon, said step for monitoring said step for injecting carbon comprising the following steps:
comparing said concentration of nitrites with a fifth predetermined threshold value S5;
stopping said carbon input step as soon as said nitrites concentration is lower than said fifth threshold value S5.

To convert the nitrites into molecular nitrogen gas, the heterotrophic bacteria consume organic carbon. However, certain types of water to be treated have a relatively low organic carbon content. It is then necessary to inject a carbonaceous substrate into the reactor during the anoxic phases. The inventors have noted that, if the addition of such a carbonaceous substrate into the reactor is excessively great, this easily biodegradable carbonaceous substrate will not be totally consumed during the corresponding anoxic phase and the oxygen injected into the reactor during the following aerated phase will be used chiefly by the heterotrophic bacteria to reduce this excess carbonaceous substrate, and not by the AOB bacteria to form nitrites from ammonium. In this case, it is noted that, in the next aerated phase, the kinetics of nitrite formation diminish greatly but also that there is a great increase in the quantity of sludges formed by the swift development of heterotrophic bacteria, as well as an excessive consumption of oxygen. In addition, an excessively great injection of carbonaceous substrate induces high costs of operation. Thus, the fact of stopping the injection of carbon into the reactor when the nitrite concentration becomes smaller than a predetermined threshold makes it possible to adjust the quantities of carbon injected into the reactor according to need and to prevent overdosing and these negative consequences during the following aerated phase. The costs inherent in the injections of carbon, the injection of oxygen and the discharge of the excess sludge produced are thus reduced and the cleansing performance of the method is secured. In addition, the duration of the steps of the method is reduced. This produces an equal quantity of treated water while at the same time reducing the size of the batch reactor implemented for this purpose.

Besides, during the anoxic denitritation phase, the heterotrophic bacteria consume first of all the nitrites and the carbon to form NO. They then consume the NO and carbon to form nitrogen protoxide. They finally consume this nitrogen protoxide and carbon to form N₂. The input of carbon into the reactor during this denitritation phase prevents the emergence of carbon deficiency in the reactor which could prevent the heterotrophic bacteria from consuming nitrogen protoxide to form N₂ Thus, the discharge of nitrogen protoxide into the atmosphere during the anoxic denitritation phase is prevented.

According to this first embodiment, said fourth threshold value S4 ranges advantageously from 1 mgN-NH₄/L to 400 mgN-NH₄/L, and preferably from 10 mgN-NH₄/L to 200 mgN-NH₄/L, and said fifth threshold value S5 advantageously ranges from 0 mgN-NO₂/L to 120 mgN-NO₂/L, and preferably from 0 mgN-NO₂/L to 50 mgN-NO₂/L.

According to a second embodiment, said anoxic denitritation step comprises a step for putting said water into contact with anammox bacteria.

The method according to the invention then works in a nitritation-deammonification configuration: a part of the ammonium ions is converted into nitrites by AOB bacteria, and then the nitrites and the rest of ammonium ions are converted into molecular nitrogen gas by anammox bacteria.

The water to be treated may or not be alkalinity-deficient according to the value of its Total Alkalinity (TA).

When the water to be treated is alkalinity-deficient, the conditions prevailing within the reactor enable the total conversion into nitrites of the ammonia contained in the volume of water for treatment that is introduced into it.

In a first variant of the second embodiment in which the water to be treated is not deficient in alkalinity, the method comprises an in-line measurement of the concentration of ammonium ions in said water present in said reactor (10) and said aerated nitritation step (ii) is preferably followed by a second step for feeding without aeration, said method comprising a step for monitoring said second step for feeding without aeration which comprises the following steps:
computing the ratio of said ammonium concentration to said nitrites concentration;
comparing said ratio with a sixth threshold value S6;
verifying the level of water in said reactor;
stopping said second step (i) for feeding as soon as said ratio is higher than said sixth threshold value S6 or as soon as the high level of said reactor is reached.

All the ammonium of the first portion of water for treatment introduced into the reactor is converted into nitrites at the end of the first feeding. A second feeding is then implemented. This is stopped as soon as the concentration of ammonium and of nitrites within the reactor is propitious to the treatment of ammonium and nitrites by the anammox bacteria. A denitritation step implementing anammox bacteria can then be implemented.

When the water to be treated is alkalinity-deficient, the pH enabling the AOB bacteria to work cannot be preserved without the addition of an alkalinizing reagent, giving rise to an additional cost. The conditions prevailing within the reactor then do not enable the total conversion into nitrites of the ammonia contained in the volume of water for treatment introduced into this reactor.

In a second variant of the second embodiment in which the water to be treated is deficient in alkalinity, the method comprises an in-line measurement of the concentration of ammonium ions in said water present in said reactor, and said step for monitoring said aerated step (ii) of nitritation preferably also comprises the following steps:
computing the ratio of said ammonium concentration to said concentration of nitrites;
comparing said ratio with a sixth threshold value S6;
stopping said aerated nitritation step (ii) as soon as said concentration of nitrous acid is higher than said second predetermined threshold value S2 or said ratio is lower than said sixth threshold value S6.

The nitritation is then stopped as soon as the ammonium and nitrites concentrations within the reactor favor the treatment of ammonium and nitrites by anammox bacteria and before the HNO2 threshold for inhibiting AOB and anammox bacteria is reached, so that the implementation of the method is optimized and the production of nitrogen protoxide is controlled.

When the method according to the invention works in nitritation-deammonification mode, when the aerated nitritation step is followed by a second non-aerated step for feeding (first variant of the second embodiment in which the effluent is not alkalinity-deficient) and when this method comprises several steps for feeding said sequencing reactor, the step for aerated feeding at the end of which the high level of said sequencing reactor is reached constituting a final step for feeding, said final step for feeding being followed by a final step for monitoring the aeration, said final step for monitoring the aeration comprises the following steps:
comparing said nitrous acid concentration with said second predetermined threshold value S2;
computing the ratio between said concentration of ammonium ions and said nitrites concentration;
comparing said ratio with said sixth threshold value S6;
stopping said aeration as soon as said ratio is lower than said sixth threshold value S6 or said nitrous acid concentration is higher than said second threshold value S2.

According to this second embodiment, said sixth threshold value S6 advantageously ranges from 0.6 to 1.2 and preferably from 0.6 to 1.

According to the first and second embodiments, said first threshold value S1 advantageously ranges from 1 mgN/L to 400 mgN/L and preferably from 10 mgN/L to 200 mgN/L, said second threshold value S2 advantageously ranges from 0.01 gN-HNO₂/L to 20 gN-HNO₂/L and preferably ranges from 0.2 μgN-HNO₂/L to 5 gN-HNO₂/L, said third threshold value S3 advantageously ranges from 0 mgN-NO₂/L to 120 mgN-NO₂/L and preferably ranges from 0 mgN-NO₂/L to 50 mgN-NO₂/L.

### 6. LIST OF FIGURES

Other features *and advantages of the invention shall appear more clearly from the following description of different preferred embodiments, given by way of simple, illustratory and non-exhaustive examples, and from the appended drawings, of which:

FIG. 1 is a diagram relating to a prior-art method for reducing nitrogen pollution by nitrification-denitrification;

FIG. 2 is a diagram relating to a prior-art method for reducing nitrogen pollution by “nitrate shunt” nitritation-denitritation;

FIG. 3 is a diagram relating to a prior-art method for reducing nitrogen pollution by nitritation-deammonification;

FIG. 4 is a graph representing the variations of pH and concentrations in O₂, NO₂, HNO₂ and in N₂O in a reactor within which the method for treating water by nitritation-denitritation is implemented;

FIG. 5 shows a water treatment installation according to the invention;

FIG. 6 is a flowchart illustrating the different steps of a method according to the invention for treating by “nitrate shunt” an effluent having little or no biodegradable COD;

FIG. 7 is a flowchart illustrating the different steps of a method according to the invention for treating by “nitrate shunt” an effluent having biodegradable COD;

FIG. 8 is a flowchart illustrating the different steps of a method according to the invention for treating an effluent that is not deficient in alkalinity by “nitritation-deammonification”;

FIG. 9 is a flowchart illustrating the different steps of a method according to the invention for treating an alkalinity-deficient effluent by “nitritation-deammonification”;

FIG. 10 illustrates the profiles of NO₂ and N₂O concentrations and pH during a full SBR cycle during a classic treatment of water by nitritation-denitritation;

FIG. 11 illustrates the profiles of the NO₂, HNO₂, N₂O, O₂ concentrations and pH during a full SBR cycle with an HNO₂ threshold S2 equal to 1.5 μgN-HNO₂/L.

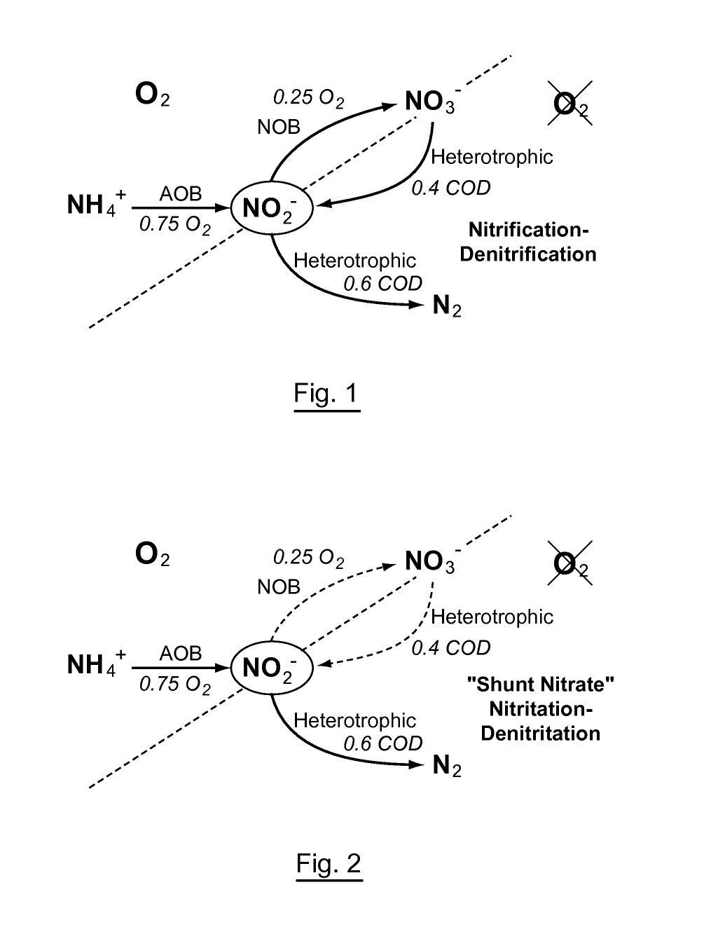

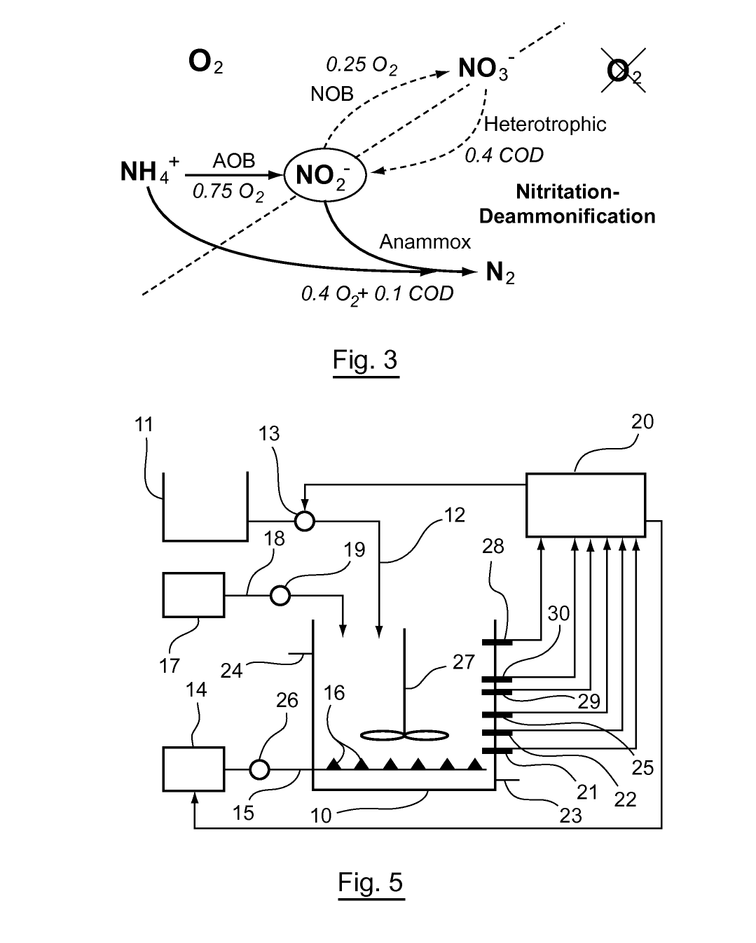

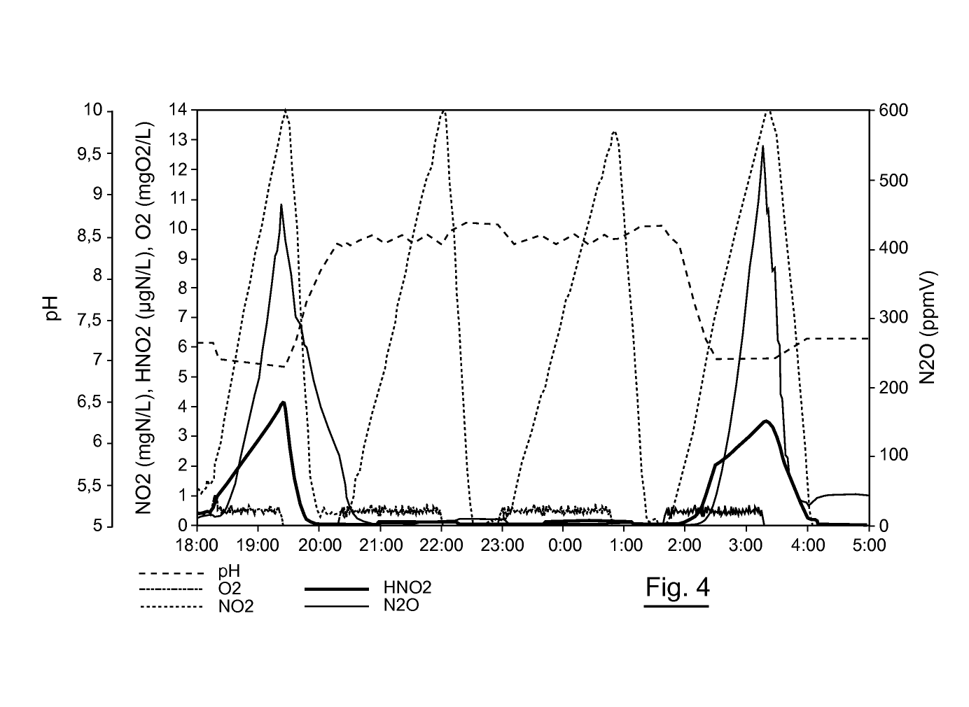

### 7. DESCRIPTION OF ONE EMBODIMENT OF THE INVENTION

### 7.1. Reminder of the Principle of the Invention

The general principle of the invention relies on the implementation, in a method for treating water charged with nitrogen in ammonium form by nitritation-denitritation, of a step for the in-line measurement of the nitrates concentration in the water present in the sequencing batch reactor within which the nitritation and denitritation reactions take place, a step for measuring the pH of this water, and a step for determining the nitrous acid concentration in the reactor from the measurement of the nitrites concentration and the measurement of the pH, and a step for monitoring the duration of said aerated step (ii) of nitritation according to said concentration of nitrous acid.

Such an implementation prevents or at least greatly limits the production of nitrogen protoxide, a powerful greenhouse gas, when implementing a method for treating water by nitritation-denitritation.

### 7.2. Example of a Plant According to the Invention

Referring to FIG. 5, we present an embodiment of an installation for treating water according to the invention.

As represented in this FIG. 5, an installation of this kind comprises a means for feeding water to a sequencing batch reactor 10 housing a stirrer 27.

The feeding means comprise:
a buffer tank 11 that is to contain water to be treated enriched with nitrogen in ammonium form;
a feed piping 12 which places the buffer tank 11 in connection with the sequencing batch reactor 10, and
a pump 13 which, depending on whether or not it is implemented, enables the feeding or non-feeding of water to be treated to the sequencing batch reactor 10.

Aeration means enable the injection of oxygen into the sequencing batch reactor 10. These aeration means comprise a blower 14 and an oxygen regulation valve 26 which are connected via a piping 15 to air diffusers 16. These air diffusers 16 are housed in a lower part of the sequencing batch reactor 10.

Carbon injection means enable the injection of the carbonaceous substrate into the sequencing batch reactor 10. These injection means comprise a tank 17 that is to contain the carbonaceous substrate, an injection piping 18 connecting the tank 17 and the sequencing batch reactor 10, and a pump 19 which, depending on whether or not it is implemented, enables the injection or non-injection of this substrate into this sequencing batch reactor 10.

This plant comprises monitoring means to monitor the means for feeding water to the sequencing batch reactor 10, means for aerating the sequencing batch reactor 10 and means for injecting carbon into the sequencing batch reactor.

These monitoring means comprise a control cabinet 20 which can, for example, comprise a microcontroller or a computer as well as an ammonium ion probe 21, a nitrite probe 22, an oxygen probe 25, a pH probe 29 and a temperature probe 30 which are intended for measuring the concentration of ammonium, nitrites and oxygen, the pH and the temperature of the water contained in the sequencing batch reactor 10. They also comprise a sensor 28 of high levels to detect whether the maximum water level in the sequencing reactor 10 has been reached.

The purpose of the control cabinet 20 is to determine the nitrous acid concentration from the nitrites concentration, the pH the temperature, and to compare the nitrous acid concentration and the measurements made by means of the ammonium probe 21, nitrite probe 22 and oxygen probe 25 with threshold values and, accordingly, to guide the implementation of the pump 13, the pump 19, the blower 14 and the O₂ regulation valve 26 as explained in detail here below. It is also capable of determining whether the water in the reactor has reached the high level of this reactor.

The sequencing batch reactor 10 has a sludge extraction piping 23 and a piping 24 for extracting treated water.

The implementation of the oxygen probe enables the oxygen concentration in the reactor to be regulated. The oxygen regulation could for example work on set values: in the aerated phase, when the value measured at the oxygen probe is greater than a set value, the cabinet directs the oxygen regulation valve so that less oxygen is delivered into the SBR. Conversely, when the value measured at the oxygen probe is smaller than the set value, the cabinet directs the oxygen regulation valve so that more oxygen is delivered into the SBR. In practice, this set value will range from 0.1 to 3 mg O₂/L.

In one variant that is not shown, the ammonium probe can be replaced by a conductivity probe. It is indeed well known to those skilled in the art that it is possible, from the conductivity of the water situated in the sequencing batch reactor, to deduce its approximate ammonium concentration.

### 7.3. Examples of Methods According to the Invention

7.3.1. “Nitrate Shunt” Configuration

### 7.3.1.1 Case of an Effluent Containing Very Little Biodegradable COD

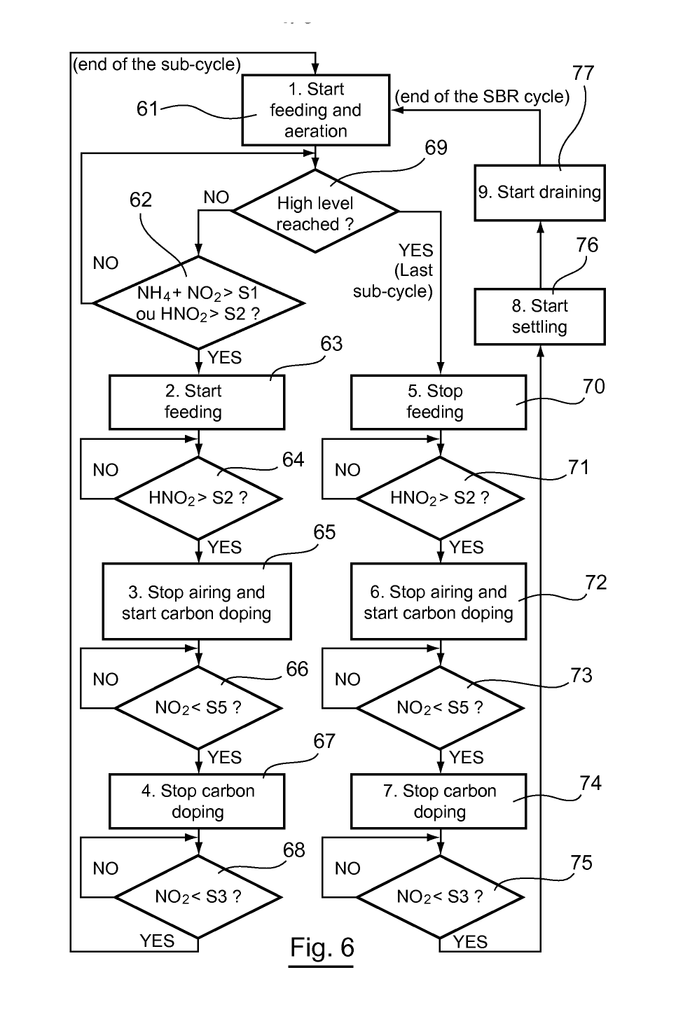

A method according to the invention for treating water charged with nitrogen in ammonium form and weakly charged with biodegradable COD, implementing a nitrate shunt type process, shall now be described with reference to FIG. 6.

According to this embodiment, the method for treating consists in treating the water in successive portions of the total volume to be treated.

According to such a method, the sequencing batch reactor 10 is fed with water to be treated (step 61 To this end, the control cabinet 20 directs the implementation of the pump 13 so that a portion of the total volume of water to be treated contained in the buffer tank 11 is shed through the feed piping 12 into the sequencing batch reactor 10.

The control cabinet 20, working in parallel, i.e. during the phase for feeding the reactor, directs the implementing of the blower 14 and that of the oxygen control valve 26 so that oxygen is introduced into the sequencing batch reactor 10 through the piping 15 and the air diffusers 16 (step 61).

An activity of the AOB bacteria is then observed inside the sequencing batch reactor 10. The water to be treated contained in the sequencing batch reactor 10 thus undergoes an aerated nitritation step.

During the nitritation, the AOB bacteria act on the ammonium ions present in the water contained in the sequencing batch reactor 10 to form nitrites by consuming oxygen.

The pH, the temperature and the nitrites, ammonium and oxygen concentrations of the effluent contained in the reactor 10 are measured in line by using the control cabinet 20, the nitrites probe 22, ammonium probe 21, pH probe 29, temperature probe 30 and oxygen probe 25. In one variant, it is possible for these measurements to be done not continuously but for example at a regular frequency. From the nitrites concentration, the pH and the temperature, the control cabinet 20 computes the nitrous acid concentration of the effluents according to the formula:

[HNO₂]=[NO₂⁻]×10^{-pH}×e^{2300/(273+T)}

with T in ° C., HNO₂ and NO₂ in mgN/L.

In one variant, the nitrous acid concentration can be computed according to the following formula:

[HNO₂]=[NO₂⁻]×10^{-PH}×10^{pKa}

for a given temperature.

The feeding of the reactor with water is monitored (step 62). During this monitoring of the feeding, the control cabinet 20:
computes the sum of the nitrites concentration and the ammonium concentration;
compares the sum with a first threshold value S1 equal to 90 mgN/L;
compares the nitrous acid concentration with a second predetermined threshold value S2 equal to 1.5 μgN-HNO₂/L;
verifies the level of water in said reactor.

As soon as this sum is higher than the first threshold value S1 or the nitrous acid concentration is higher than the second predetermined threshold value S2 or the water in the reactor has reached a high level, the control cabinet 20 stops the working of the pump 13 so that the feeding of water to be treated to the sequencing batch reactor 10 is stopped (step 63).

The duration of the aerated nitritation step is monitored (step 64). During this monitoring, the control cabinet 20 compares the HNO₂ concentration with the second predetermined threshold value S2 equal to 1.5 μgN-HNO₂/L.

As soon as the HNO₂ concentration of nitrites is higher than said second predetermined threshold value S2, the control cabinet directs the blower 14 and the oxygen regulation valve 26 so that it no longer delivers oxygen into the sequencing batch reactor 10. Consequently, the aerated nitritation step comes to an end (step 65).

An activity of the heterotrophic bacteria is then observed inside the sequencing batch reactor 10. The water to be treated contained in the sequencing batch reactor 10 thus undergoes an anoxic denitritation step.

During the denitritation, the heterotrophic bacteria act on the nitrites present in the water contained in the sequencing batch reactor 10 to form molecular nitrogen gas in consuming the carbonaceous substrate present in the sequencing batch reactor 10

The anoxic denitritation step comprises a step for carbon input into the sequencing batch reactor 10 (step 65). This carbon input is monitored (step 66). During the monitoring of the carbon input, the control cabinet 20 compares the nitrites concentration with a fifth predetermined threshold value S5 equal to 4 mgN-NO₂/L.

As soon as the nitrites concentration is lower than this fifth threshold value S5, the control cabinet directs the pump 19 so that the injection of carbon into the sequencing batch reactor 10 is stopped (step 67). The injected carbon may take the form of a liquid, a solution of methanol, ethanol or glycerol or any other carbonaceous substrate.

The duration of the anoxic denitritation step is monitored (step 68). During this monitoring, the control cabinet 20 compares the nitrites concentration with a third predetermined threshold value S3 equal to 2 mgN-NO₂/L.

As soon as the nitrites concentration gets lower than this third predetermined threshold value S3, the control cabinet 20 directs the anoxic denitritation step to a stop.

Further steps of feeding, aerated nitritation and then anoxic denitritation are implemented so as to treat a new portion of the total volume of water to be treated. In this embodiment, the treatment method therefore comprises several sub-cycles each comprising a feeding step, an aerated nitritation step and an anoxic denitritation step. A plurality of sub-cycles is implemented until the high level 28 of the biological reactor 10 is attained (step 69), the last sub-cycle being implemented to treat the last volume of water introduced into the reactor 10 so that it is full.

As soon as the entire volume of water is treated, i.e. as soon as the high level 28 of the biological reactor 10 has been reached (step 69) and the last sub-cycle is terminated (steps 70 to 75), the stirring within the sequencing batch reactor 10 is stopped, so that the water contained in this reactor undergoes a settling process (step 76). The suspended matter is then separated from the treated water. Once the settling is terminated, the phases for extracting or draining water and sludges start (step 77). The sludges formed during this settling are extracted from the reactor through the extraction piping 23. The draining of the SBR is never total. On the contrary, the principle is that of keeping a part of the sludges after settling. The aeration of the reactor is therefore never done in a vacuum. The treated water is extracted from the reactor through the extraction piping 24.

In this embodiment, one full treatment cycle, i.e. a cycle enabling the treatment of the entire volume of water to be treated (volume defined by the high level 28 of the reactor 10) therefore comprises several sub-cycles (feeding, aerated nitritation and anoxic denitritation), a settling and an extraction of treated water and sludges. The extraction of the sludges enables checks on the sludge age of the method.

In this embodiment, the feeding with water and the aeration of the reactor are monitored, especially on the basis of the nitrous acid concentration in the reactor so as to limit the production of nitrogen protoxide. In one variant, only the duration of the aerated nitritation step can be monitored as a function of this piece of data.

In one variant, all the volume of the water to be treated can be introduced into the sequencing batch reactor 10 only once. In this case, only one sub-cycle will be implemented.

### 7.3.1.2 Case of an Effluent Containing Biodegradable COD

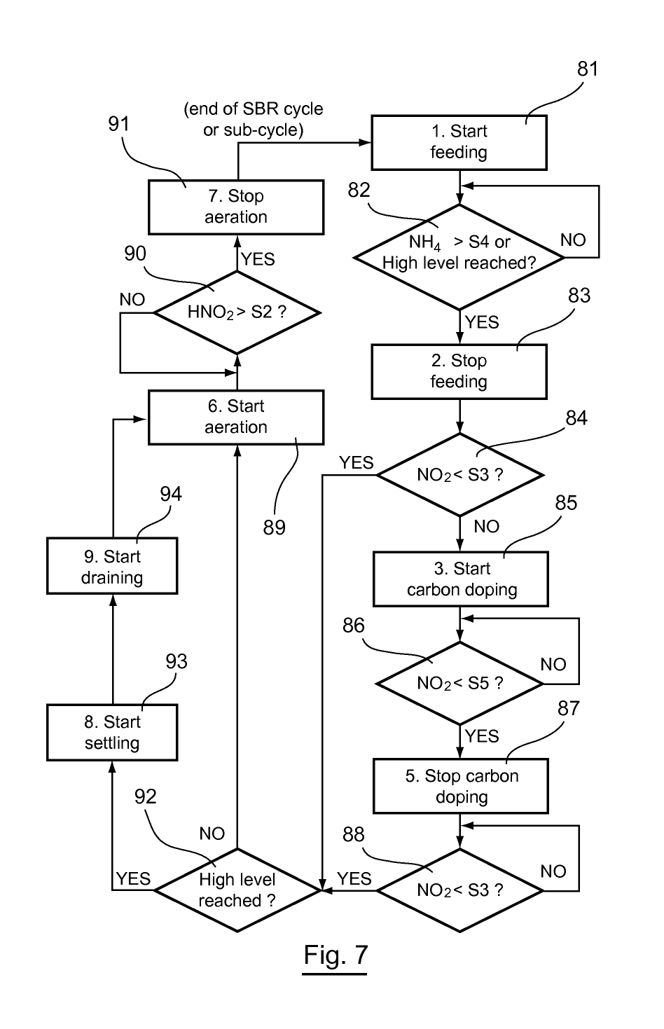

A method according to the invention for treating water charged with nitrogen in ammonium form and charged with biodegradable COD implementing a nitrate shunt type process shall now be described with reference to FIG. 7.

According to this embodiment, the method for treating consists in treating water by successive portions of the total volume to be treated.

According to such a method, the sequencing batch reactor 10 is supplied with water to be treated (step 81). To this end, the control cabinet 20 directs the implementation of the pump 13 so that a portion of the total of water to be treated contained in the buffer tank 11 is shed through the feeder piping 12 into the sequencing batch reactor 10.

The sequencing reactor 10 is not aerated during its feeding.

An activity of the heterotrophic bacteria is then observed inside the sequencing batch reactor 10. The water to be treated contained in the sequencing batch reactor 10 thus undergoes an anoxic denitritation step.

The ammonium concentration is measured and the level of water in the sequencing reactor 10 is monitored by implementing the control cabinet 20, the ammonium probe 21 and the level sensor 28.

The feeding of the reactor with water is monitored (step 82). During this monitoring of the feeding, the control cabinet 20:
compares the concentration of ammonium ions with a fourth threshold value S4 equal to 80 mgN-NH4/L;
checks to see whether the level of water in the reactor has reached the high level.

As soon as the concentration of ammonium ions gets higher than the fourth threshold value S4 or as soon as the high level of the sequencing reactor 10 has been reached, the control cabinet 20 stops the working of the pump 13 so that the feeding of the sequencing batch reactor 10 with water to be treated is stopped (step 83).

During the denitritation, the heterotrophic bacteria act on the nitrites present in the water contained in the sequencing batch reactor 10 to form molecular nitrogen gas in consuming the carbonaceous substrate present in the sequencing batch reactor 10.

The anoxic denitritation step comprises, if necessary, a step of carbon input or doping in the sequencing batch reactor 10 (step 85). The activation of this carbon input step is monitored (step 84). In order to activate or not activate the carbon supply step, the control cabinet measures the nitrites concentration in the sequencing reactor 10 by implementing the nitrites probe 22. It compares the nitrites concentration with the third threshold value S3 equal to 2 mgN-NO2/L. If the nitrites concentration is higher than this third threshold value S3, the carbonaceous substrate input is made. If not, the carbonaceous substrate input is not made and the aeration of the sequencing reactor 10 is then carried out if the high level in the reactor is not reached or the starting of the settling is carried out if the high level in the reactor is reached.

This carbon input is monitored (step 86). During the monitoring of the carbon input, the control cabinet 20 compares the nitrites concentration with a fifth predetermined threshold value S5equal to 4 mgN-NO₂/L.

As soon as the nitrites concentration is lower than this fifth threshold value S5, the control cabinet directs the pump 19 so that the injection of carbon into the sequencing batch reactor 10 is stopped (step 87). The injected carbon can take the form of a liquid, a solution of methanol, ethanol or glycerol or any other carbonaceous substrate.

The duration of the anoxic denitritation step is monitored (step 88). During this monitoring, the control cabinet 20 compares the nitrites concentration with a third predetermined threshold value S3 equal to 2 mgN-NO₂/L.

As soon as the nitrites concentration is lower than this third predetermined threshold value S3, the control cabinet 20 directs the stopping of the anoxic denitritation step.

The control cabinet 20 then directs the implementation of the blower device 14 and the oxygen regulation valve 26 so that the oxygen is introduced into the sequencing batch reactor 10 through the piping 15 and the air diffusers 16: the reactor is aerated (step 89).

An activity of AOB bacteria is then observed within the sequencing batch reactor 10. The water to be treated contained in the sequencing batch reactor 10 thus undergoes an aerated nitritation step.

During the nitritation, the AOB bacteria act on the ammonium ions present in the water contained in the sequencing batch reactor 10 to form nitrites by consuming oxygen.

The pH, the temperature and the concentration of nitrites, ammonium and oxygen of the effluent contained in the reactor 10 are measured in line by the implementation of the control cabinet 20, the nitrites probe 22, the ammonium probe 21, the pH probe 29, the temperature probe 30 and the oxygen prove 25. In one variant, it is possible for these measurements to be done not continuously but for example at a regular frequency. From the nitrites concentration, the pH and the temperature, the control cabinet 20 computes the nitrous acid concentration of the effluent according to the formula:

[HNO₂]=[NO₂⁻]×10^{-pH}×e^{2300/(273+T)}

with T in ° C., HNO₂ and NO₂ in mgN/L.

In one variant, the concentration of nitrous acid could be computed according to the following formula:

[HNO₂]=[NO₂⁻]×10^{-pH}×10^{pKa}

for a given temperature.

The duration of the aerated nitritation step is monitored (step 90). During this monitoring, the control cabinet 20 compares the HNO₂ concentration with the second predetermined threshold value S2 equal to 1.5 μgN-HNO₂/L.

As soon as the HNO₂ concentration is higher than the second predetermined threshold value S2, the control cabinet directs the blower 14 and the oxygen regulation valve 26 so that it no longer delivers oxygen into the sequencing batch reactor 10. Consequently, the aerated nitritation step comes to an end (step 91).

Further steps for feeding, anoxic denitritation and then aerated nitritation are implemented so as to treat a new portion of the total volume of water to be treated. In this embodiment, the method for treating therefore comprises several sub-cycles each comprising a step for feeding, a step for anoxic denitritation and a step for aerated denitritation. A plurality of sub-cycles is implemented until the high level 28 of the biological reactor 10 is reached (step 92), the last sub-cycle being implemented to treat the last volume of water introduced into the reactor 10 so that it is full.

As soon as the volume of water is treated, i.e. as soon as the high level 28 of the biological reactor 10 is reached (step 92) and the last sub-cycle is terminated, the stirring within the sequencing batch reactor 10 is stopped so that the water contained in this reactor undergoes a settling process (step 93). The matter in suspension is then separated from the treated water. Once the settling is terminated, the phases for extracting or draining water and sludges begins (step 94). The sludges formed during this settling are extracted from the reactor through the extraction piping 23. The draining of the SBR is never total. On the contrary, the principle is to keep a part of the sludges after settling. The aeration of the decanter is therefore never done in vacuum. The treated water is extracted from the reactor through the extraction piping 24.

In this embodiment, a full treatment cycle, i.e. a cycle enabling the treatment of all the volume of water to be treated (volume defined by the high level 28 of the reactor 10) therefore comprises several sub-cycles (feeding, anoxic denitritation and aerated denitritation), settling and extraction of treated water and sludges. The extraction of sludges enables checks on the sludge age of the method.

In one variant, all the volume of water to be treated could be introduced into the sequencing batch reactor 10 only once. In this case, only one sub-cycle will be implemented.

In this embodiment, the feeding with water and the aeration of the reactor are monitored, especially through the nitrous acid concentration in the reactor in such a way as to limit the production of nitrogen protoxide. In one variant, only the duration of the aerated nitritation step can be monitored from this data.

7.3.2. Nitritation-Deammonification Configuration

### 7.3.2.1 Case of an Effluent Not Deficient in Alkalinity

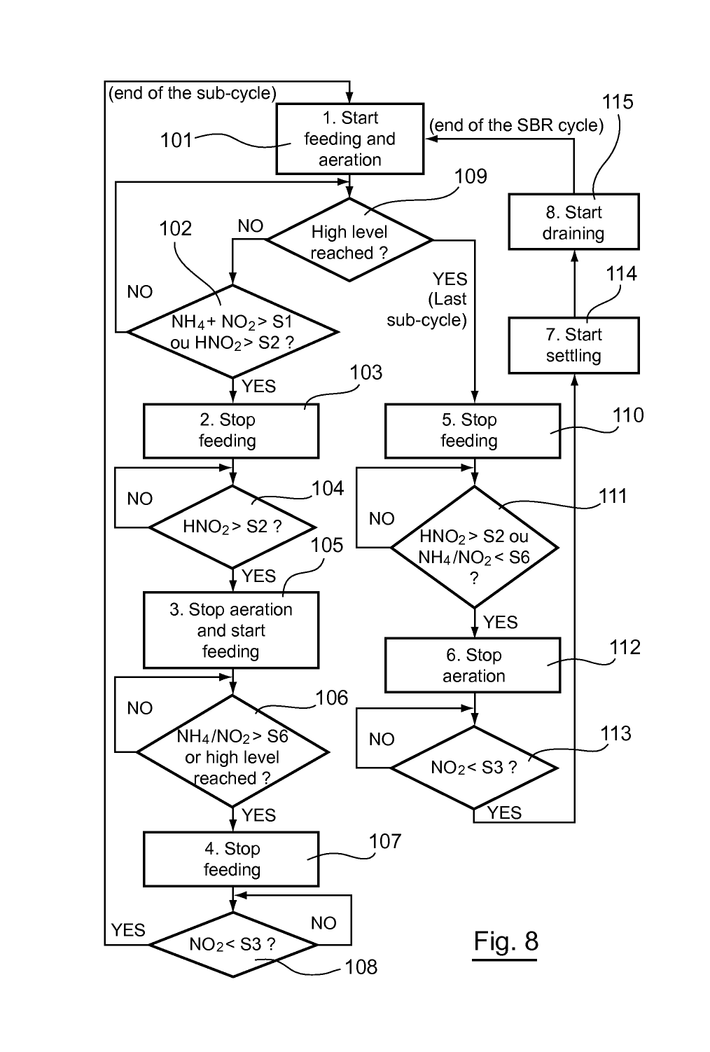

A method according to the invention for treating water charged with nitrogen in ammonium form that is not deficient in alkalinity, implementing a nitritation/deammonification process by means of anammox bacteria in a single sequencing batch reactor shall now be described with reference to FIG. 8.

According to this embodiment, the method for treating consists in treating the water in successive portions of the total volume to be treated.

According to such a method, the sequencing batch reactor 10 is fed with water to be treated during a first feeding step (step 101). To this end, the control cabinet 20 directs the implementation of the pump 13 so that a portion of the total volume of water to be treated contained in the buffer tank 11 is shed through the feed piping 12 into the sequencing batch reactor 10.

The control cabinet 20 directs the implementation of the blower 14 and the oxygen regulation valve 26 in parallel so that the oxygen is introduced into the sequencing batch reactor 10 through the piping 15 and the air diffusers 16. The reactor is aerated (step 101).

An activity of AOB bacteria is then observed within the sequencing batch reactor 10. The water to be treated contained in the sequencing batch reactor 10 thus undergoes an aerated nitritation step in which the AOB bacteria are involved.

During the nitritation, the AOB bacteria act on the ammonium present in the water contained in the sequencing batch reactor 10 to form nitrites by consuming oxygen.

The pH, the temperature and the nitrites, ammonium and oxygen concentrations of the effluent contained in the reactor 10 are measured in line by the implementation of the control cabinet 20, the nitrite probe 22, the ammonium probe 21, pH 29, the temperature probe 30 and the oxygen probe 25. The nitrites probe 22 enables the in-line measurement of the nitrites concentration of the water contained in the sequencing batch reactor 10. The ammonium measuring probe 21 enables the in-line measurement of the ammonium concentration of the water contained in the sequencing batch reactor 10.

From the concentration of nitrites, the pH and the temperature, the control cabinet 20 computes the nitrous acid concentration of the effluent according to the formula:

[HNO₂]=[NO₂⁻]×10^{-pH}×e^{2300/(273+T)}

with T in ° C., HNO₂ and NO₂ in mgN/L.

In one variant, the nitrous acid concentration can be computed according to the following formula:

[HNO₂]=[NO₂⁻]×10^{-pH}×10^{pKa}

for a given temperature.

The feeding of the reactor with water is monitored (step 102). During this monitoring of the feeding, the control cabinet 20:
computes the sum of the nitrites concentration and the ammonium concentration;
compares the sum with a first threshold value S1 equal to 90 mgN/L;
compares the nitrous acid concentration with a second threshold value S2 equal to 1.5 μgN-HNO₂/L;
verifies the level of water in said reactor.

As soon as this sum is higher than the first threshold value, or the nitrous acid concentration is higher than the second threshold value S2, or the water in the reactor has reached a high level, the control cabinet 20 stops the working of the pump 13 so that the feeding of the sequencing batch reactor 10 with water to be treated is stopped (step 103).

The duration of the aerated step of nitritation is monitored (step 104). During this monitoring, the control cabinet 20 compares the HNO₂ concentration with the second threshold value S2 equal to 1.5 μgN-HNO₂/L.

As soon as the HNO₂ concentration is higher than said second predetermined threshold value S2, the control cabinet directs the blower 14 and the oxygen regulation valve 26 so that it no longer delivers oxygen to the interior of the sequencing batch reactor 10. Consequently, the aerated step of nitritation comes to an end (step 105).

A second feeding operation, without aeration, is performed (step 105). The second operation for feeding the reactor with water is monitored (step 106). During this monitoring of the feeding, the control cabinet 20:
computes the ratio of the ammonium concentration to the nitrites concentration;
compares the ratio with said sixth threshold value S6 equal to 0.8;
verifies the water level in the reactor.

As soon as this ratio is higher than said sixth threshold value S6, or as soon as the water in the reactor has reached the high level, the control cabinet 20 stops the working of the pump 13 so that the feeding of the sequencing batch reactor 10 with water to be treated is stopped (step 107).

The ammonium and nitrite concentrations are then propitious to the treatment of ammonium and the nitrites contained in the effluent. An activity of the anammox bacteria is then observed inside the sequencing batch reactor 10. The water to be treated contained in the sequencing batch reactor 10 then undergoes an anoxic deammonification step.

During the anoxic phases, the anammox bacteria act on the ammonium and on the nitrites present in the water to form molecular nitrogen gas.

The duration of the anoxic deammonification step is checked (step 108). During this check, the control cabinet 20 compares the nitrites concentration with said third predetermined threshold value S3 equal to 2 mgN-NO₂/L.

As soon as the nitrites concentration is lower than this third predetermined threshold value S3, the control cabinet 20 directs the stopping of the anoxic deammonification step.

Further steps of first feeding, of aerated nitritation, of second feeding, then anoxic deammonification are implemented so as to treat a new portion of the total volume of water to be treated. In this embodiment, the method for treating therefore comprises several sub-cycles each comprising a first feeding step, a step of aerated nitritation, a second step for non-aerated feeding and a step of anoxic deammonification. A plurality of sub-cycles is implemented until the high level 28 of the biological reactor 10 is reached during a step of aerated or non-aerated feeding (steps 101 or 105). This high level stops the feeding (step 106 or 109). The rest of the sub-cycle initiated by the feeding is implemented (steps 108 to 112): the carrying out of an aerated nitritation step followed by a step of anoxic deammonification.

The duration of this last aerated nitritation step is monitored (step 111). During this monitoring, the control cabinet 20:
computes the ratio between the concentration of ammonium ions and the concentration of nitrites;
compares this ratio with the sixth threshold value S6 equal to 0.8;
compares the HNO₂ concentration with the second threshold value S2 equal to 1.5 μgN-HNO₂/L.

As soon as the HNO₂ concentration is higher than said second predetermined threshold value S2, or the ratio is lower than the sixth threshold value S6, the control cabinet directs the blower 14 and the oxygen regulation valve 26 so that it no longer delivers oxygen into the sequencing batch reactor 10. Consequently, the last aerated step of nitritation comes to an end (step 112). The last anoxic deammonification step starts. It comes to an end as soon as the nitrites concentration is lower than the third threshold value S3 equal to 2 mgN-NO₂/L.

As soon as the entire volume of water has been treated, i.e. the high level 28 of the biological reactor 10 has been reached (step 109) and the last aerated phases of nitritation and anoxic deammonification have taken place (steps 110 to 113), the stirring inside the sequencing batch reactor 10 is stopped so that the water contained in this reactor undergoes a settling process (step 114). The matter in suspension in the water is then separated from the water. The reactor is drained (step 115): the sludges formed during this settling are extracted from the reactor through the extraction piping 23, and the treated water is extracted from the reactor through the extraction piping 24. The draining of the SBR is never total. On the contrary, the principle is that of preserving a part of the sludges after settling. The aeration of the reactor is therefore never done in vacuum.

In this embodiment, a full treatment cycle therefore comprises at least one sub-cycle (first feeding operation, aerated nitritation, second non-aerated feeding operation and anoxic deammonification), a settling and an extraction of treated water and sludges. The extraction of sludges makes it possible to monitor the sludge age of the method.

In one variant, the entire volume of water to be treated could be introduced into the sequencing batch reactor 10 twice, implementing only one sub-cycle.

In this embodiment, the feeding with water and aeration of the reactor are monitored especially through the nitrous acid concentration in the reactor so as to limit the production of nitrogen protoxide. In one variant, only the duration of the aerated step of nitritation could be monitored depending on this piece of data.

### 7.3.2.2 Case of an Alkalinity-Deficient Effluent

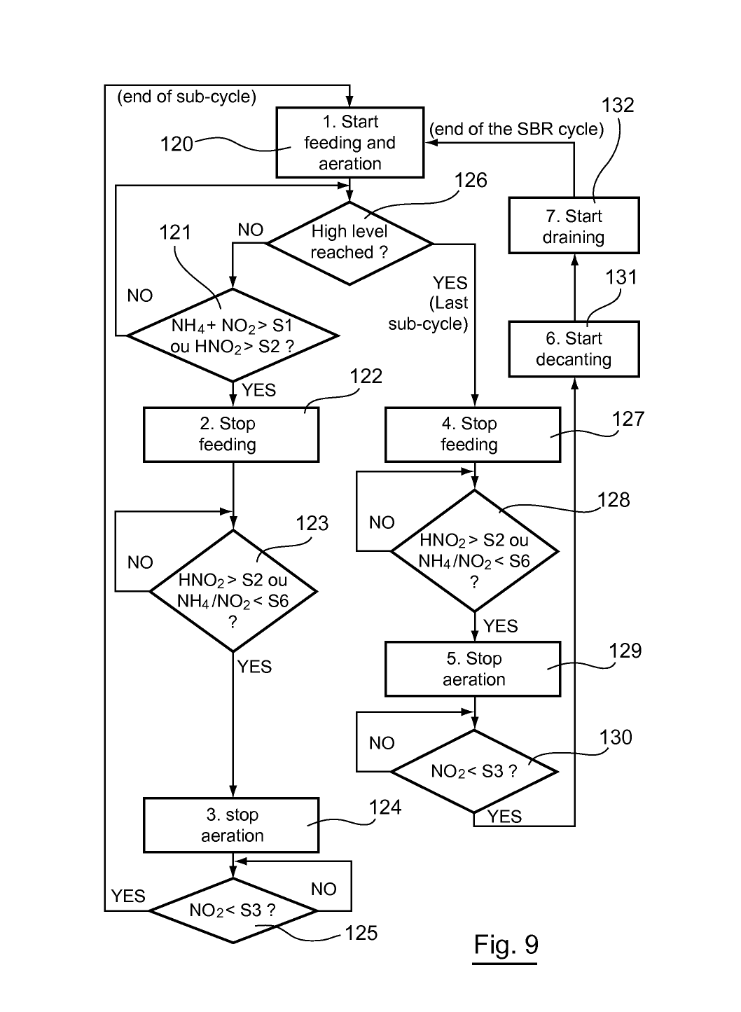

A method according to the invention for treating alkalinity-deficient water charged with nitrogen in ammonium form, implementing a process of the nitritation/deammonification type by means of anammox bacteria in only one sequencing batch reactor, shall now be described with reference to FIG. 9.

In this example, the effluent is alkalinity deficient in such a way that the total nitritation of the ammonia into nitrite is not possible, the quantity of alkalinity available in the effluent being insufficient to maintain a pH enabling the AOB bacteria to function.

In this embodiment, the method of treatment consists in treating the water by successive portions of the total volume to be treated.

According to such a method, the sequencing batch reactor 10 is fed with water for treatment. To this end, the control cabinet 20 directs the use of the pump 13 so that a portion of the total water for treatment contained in the buffer tank 11 is shed through the feed piping 12 into the sequencing batch reactor 10.

The control cabinet 20 directs the use of the blower 14 and the oxygen regulation valve 26 in parallel so that oxygen is introduced into the sequencing batch reactor 10 through the piping 15 and the air diffusers 16. The reactor is aerated (step 120).

An activity of the AOB bacteria is then observed inside the sequencing batch reactor 10. The water to be treated contained in the sequencing batch reactor 10 thus undergoes an aerated nitritation step in which the AOB bacteria are involved.

During the nitritation, the AOB bacteria act on the ammonium ions present in the water contained in the sequencing batch reactor 10 to form nitrites by consuming oxygen.

The pH, the temperature and the nitrites, ammonium and oxygen concentrations of the effluent contained in the reactor 10 are measured in line by the implementing of the control cabinet 20, the nitrites probe 22, ammonium probe 21, pH probe 29, temperature probe 30 and oxygen probe 25. The nitrites probe 22 enables the in-line measurement of the nitrites concentration of the water contained in the sequencing batch reactor 10. The ammonium measuring probe 21 enables the in-line measurement of the ammonium concentration of the water contained in the sequencing batch reactor 10.

From the nitrites concentration, pH and temperature, the control cabinet 20 computes the nitrous acid concentration of the effluent according to the formula:

[HNO₂]=[NO₂⁻]×10^{-pH}×e^{2300/(273+T)}

with T in ° C., HNO₂ and NO₂ in mgN/L.

In one variant, the nitrous acid concentration could be computed according to the following formula:

[HNO₂]=[NO₂⁻]×10^{-pH}×10^{pKa}

for a given temperature.

The feeding of the reactor with water is monitored (step 121). During this monitoring of the feeding, the control cabinet 20:
computes the sum of the nitrites concentration and the ammonium concentration;
compares the sum with a first threshold value S1 equal to 90 mgN/L;
compares the nitrous acid concentration with a second predetermined threshold value S2 equal to 1.5 μgN-HNO₂/L;
verifies the level of water in said reactor.

As soon as this sum is higher than the first threshold value S1 or the nitrous acid concentration is higher than the second threshold value S2 or the water in the reactor has reached the high level, the control cabinet 20 stops the working of the pump 13 so that the feeding of the sequencing batch reactor 10 with water to be treated is stopped (step 122).

The duration of the aerated nitritation step is monitored (step 123). During this monitoring, the control cabinet 20:
compares the nitrous acid concentration with the second predetermined threshold value S2 equal to 1.5 μgN-HNO₂/L;
computes the ratio of the ammonium concentration to the nitrites concentration and compares it with a sixth threshold value S6 equal to 0.8.

As soon as the HNO₂ concentration is higher than said second predetermined threshold value S2 or as soon as the ratio of the ammonium concentration to the nitrites concentration is lower than said sixth threshold value S6, the control cabinet directs the blower 14 and the oxygen regulation valve 26 so that it no longer delivers oxygen to the interior of the sequencing batch reactor 10. Consequently, the aerated step of nitritation comes to an end (step 124).

The ammonium and nitrite concentrations are then propitious to the treatment of ammonium and the nitrites contained in the effluent. An activity of the anammox bacteria is then observed inside the sequencing batch reactor 10. The water to be treated contained in the sequencing batch reactor 10 then undergoes an anoxic deammonification step.

During the anoxic phases, the anammox bacteria act on the ammonium and on the nitrites present in the water to form molecular nitrogen gas.

The duration of the anoxic deammonification step is monitored (step 125). During this monitoring, the control cabinet 20 compares the nitrites concentration with said third predetermined threshold value S3 equal to 2 mgN-NO₂/L.

As soon as the nitrites concentration is lower than this third predetermined threshold value S3, the control cabinet 20 directs the stopping of the anoxic deammonification step.

Further steps of feeding, aerated nitritation and then anoxic deammonification are implemented so as to treat a new portion of the total volume of water to be treated. In this embodiment, the method for treating therefore comprises several sub-cycles each comprising a feeding step, a step of aerated nitritation and a step of anoxic deammonification. A plurality of sub-cycles is implemented until the high level 28 of the biological reactor 10 is reached (step 126) during a step of feeding. This high level stops the feeding (step 127). The rest of the sub-cycle initiated by the feeding is implemented (steps 128 to 130): the carrying out of an aerated nitritation step followed by a anoxic deammonification step.

As soon as the entire volume of water has been treated, i.e. the high level 28 of the biological reactor 10 has been reached and the last aerated phases of nitritation and anoxic deammonification have taken place, the stirring inside the sequencing batch reactor 10 is stopped so that the water contained in this reactor undergoes a settling process (step 131). The matter in suspension in the water is then separated from the water. The reactor is drained (step 132): the sludges formed during this settling are extracted from the reactor through the extraction piping 23, and the treated water is extracted from the reactor through the extraction piping 24. The draining of the SBR is never total. On the contrary, the principle is that of preserving a part of the sludges after settling. The aeration of the reactor is therefore never done in vacuum.

In this embodiment, a full treatment cycle therefore comprises at least one sub-cycle (feeding, aerated nitritation, anoxic deammonification), a settling and an extraction of treated water and sludges. The extraction of sludges makes it possible to monitor the sludge age of the method.

In one variant, the entire volume of water to be treated could be introduced into the sequencing batch reactor 10 only once.

In this embodiment, the feeding with water and aeration of the reactor are monitored especially through the nitrous acid concentration in the reactor so as to limit the production of nitrogen protoxide. In one variant, only the duration of the aerated step of nitritation could be monitored depending on this piece of data.

### .7.4. Variants

The comparison of each variable measured by means of a probe with a predetermined threshold value is preferably backed-up with a safety time lag. The implementation of such safety time lags makes it possible to continue the running of the method even when one or more probes might be temporarily defective or one or more thresholds of value are never attained during the comparisons with the measured data.

### 7.5. Trials

Trials were made to attest to the efficiency of the technique according to the invention.

In these trials, within a 500-litre SBR, an effluent containing very little biodegradable COD is treated by nitrate shunt.

All the steps of the treatment were done in a same reactor sequentially. The temperature was 25° C. and the dissolved oxygen concentration during the aerated phases was low (0.5 mgO₂/L) in order to favor the shunt in the SBR. This SBR w as fed with filtrates from the draining table coming from the dehydration of the digested sludges of an anaerobic digester of a purification station. The average composition of the filtrate is presented in the table below.

| | | | | Sus- | | |
|---|---|---|---|---|---|---|
| | | Soluble | | pended | Total | |
| | N—NH₄ | COD | P—PO₄³⁻ | matters | Alkalinity | |
| | (mgN/L) | (mg/L) | (mgP/L) | (mg/L) | (° F.) | pH |
| Min | 239 | 96 | 90 | 38 | 107 | 7.4 |
| Max | 721 | 218 | 145 | 1568 | 281 | 8.1 |
| Mean | 466 | 147 | 109 | 216 | 163 | 7.68 |
| Standard | 127 | 24.2 | 12.2 | 284 | 43 | 0.2 |
| deviation | | | | | | |
| Number of | 88 | 53 | 22 | 37 | 24 | 23 |
| samples | | | | | | |

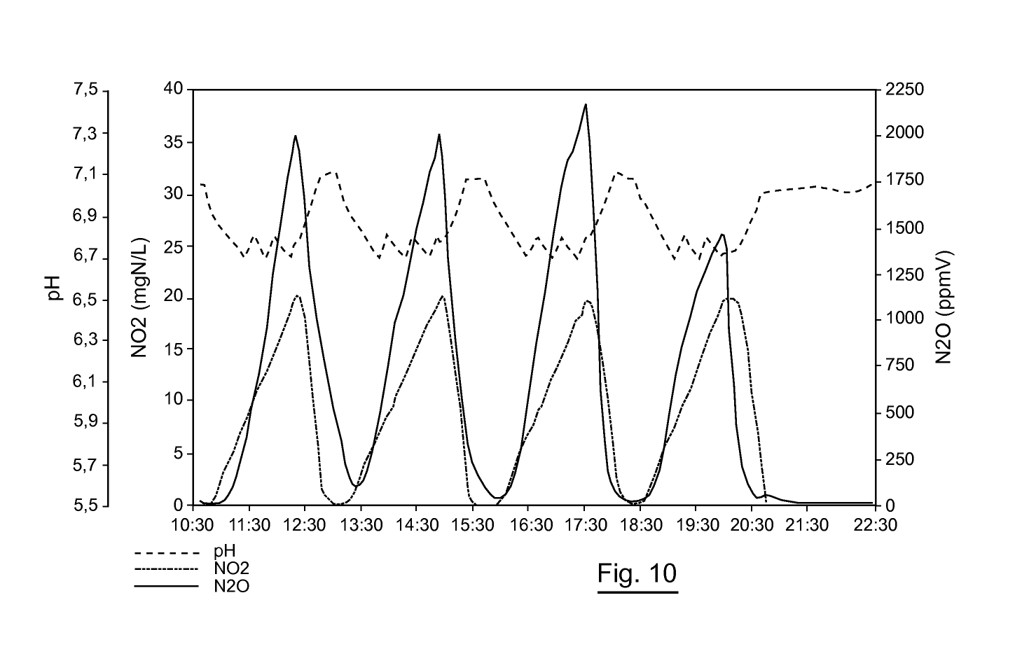

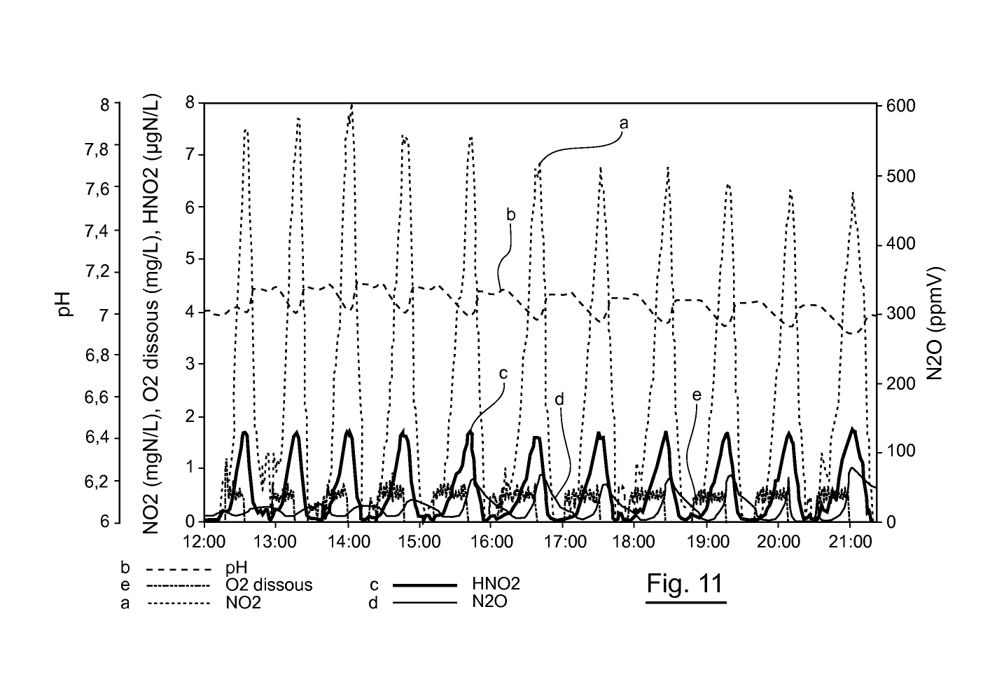

FIG. 10 illustrates the profiles of the NO₂, and N₂O concentrations and the pH during a full SBR cycle during a classic treatment of this water by nitritation-denitritation with injection of sodium hydroxide into the reactor so that the pH does not fall below 6.7 and limits the activity of the nitritizing bacteria. The production of N₂O during this cycle was 0.09 gN-N₂O/gN-NH4 reduced, i.e. 9%, and reached more than 2000 ppmv.

FIG. 11 illustrates the profiles of the NO₂, HNO₂, N₂O, O₂ concentrations and the pH during a full SBR cycle with an HNO₂ threshold S2 equal to 1.5 μgN-HNO₂/L. The production of N₂O during this cycle was equal to 0.002 gN-N₂O/gN-NH4 reduced, i.e. 0.2%, and is always below 100 ppmv without injection of sodium hydroxide into the reactor to control the pH.

The implementation of the technique of the invention therefore enables the treatment of water by nitritation-denitritation while at the same time restricting the production of nitrogen protoxide and the addition of alkalinizing reagents.

1-16. (canceled)

17. A method for treating water charged with nitrogen in the form of ammonium within a sequencing batch reactor, the method comprising:
feeding the water into the sequence batch reactor;
aerating the water and performing nitritation;
subjecting the water to anoxic conditions and performing denitritation;
measuring the concentration of nitrites in the water contained in the reactor;
measuring the pH of the water contained in the reactor;
computing the concentration of nitrous acid (HNO₂) in the water contained in the reactor based on the concentration of nitrites in the water and the pH of the water;
controlling the duration of aerating the water by:
i. comparing the concentration of nitrous acid with a second predetermined threshold value S2; and
ii. ceasing aerating the water as soon as the nitrous acid concentration becomes higher than the predetermined threshold value S2.

18. The method of claim 17 wherein the method comprises measuring the concentration of ammonium ions in the water contained in the reactor and monitoring the step of feeding the water into the reactor, and wherein the method further comprises:
i. computing the sum of the concentration of nitrites and the concentration of ammonium ions;
ii. comparing the sum with a first predetermined threshold value S1;
iii. determining the level of the water in the reactor; and
iv. ceasing the feeding of the water into the reactor as soon as the sum is higher than the first threshold value S1 or that the concentration of nitrous acid is higher than the second threshold value S2 or the level of the water in the reactor has reached a predetermined height.

19. The method of claim 17 including monitoring the duration of subjecting the water in the reactor to anoxic conditions by:
comparing the concentration of nitrates with a third predetermined threshold value S3; and
ceasing to subject the water to anoxic conditions and denitritation when the concentration of nitrites is lower than the third predetermined value S3.

20. The method of claim 17 wherein performing denitritation comprises placing the water in contact with heterotropic bacteria.

21. The method of claim 17 including measuring the concentration of ammonium ions in the water and monitoring the feeding of the water to the reactor; and the method further includes:
comparing the concentration of ammonium ions with a fourth predetermined value S4;
verifying the level of water in the reactor;
ceasing to feed water to the reactor when the concentration of ammonium ions is higher than the fourth threshold value S4 or when the water level in the reactor reaches a predetermined height.

22. The method of claim 20 wherein the process of subjecting the water to anoxic conditions comprises injecting carbon into the reactor and monitoring the injection of carbon by:
comparing the concentration of nitrites with a fifth predetermined threshold value S5; and
ceasing the injection of carbon when the nitrites concentration is lower than the fifth threshold value S5.

23. The method of claim 22 wherein the fourth threshold value S4 ranges from 1 mgN-NH₄/L to 400 mgN-NH₄/L.

24. The method of claim 23 wherein the fifth threshold value S5 ranges from 0 mgN-NO₂/L to 120 mgN-NO₂/L.

25. The method of claim 17 wherein the process of subjecting the water to anoxic conditions includes contacting the water with anammox bacteria.

26. The method of claim 25 including measuring the concentration of ammonium ions in the water and wherein aerating the water is followed by feeding water to the reactor in the absence of aeration, and monitoring the feeding by:
computing the ratio of the ammonium ion concentration to the nitrites concentration;
comparing the ratio with a sixth threshold value S6;
verifying the water level in the reactor; and
ceasing the feeding of water to the reactor when the ratio is higher than the sixth threshold value S6 or when the level of water in the reactor reaches a predetermined height.

27. The method of claim 25 including measuring the concentration of ammonium ions in the water contained in the reactor and monitoring the step of aerating the water in the reactor which gives rise to nitritation by:
computing the ratio of the ammonium ion concentration to the concentration of nitrites; and
comparing the ratio with a sixth threshold value S6; and
ceasing the aeration of the water when the concentration of the nitrous acid is higher than the second threshold value S2 or the ratio is lower than the sixth threshold value S6.

28. The method of claim 26 including several steps of feeding water to the reactor, and wherein in at least one feeding step the water is aerated, at the end of which a high level of water in the sequencing batch reactor is reached which constitutes a final step for feeding, the final step of feeding being followed by a final step for monitoring the aeration of the water, the final step for monitoring the aeration comprising:
comparing the nitrous acid concentration with said second predetermined threshold value S2;
computing the ratio between the concentration of ammonium ions and nitrites concentration;
comparing the ratio with the sixth threshold value S6; and
ceasing the aeration of the water when the ratio is below the sixth threshold value S6 or the nitrous acid concentration is higher than the second threshold value S2.

29. The method of claim 25 wherein the sixth threshold value S6 ranges from 0.6 to 1.2.

30. The method of claim 18 wherein the first threshold value S1 ranges from 1 mgN/L to 400 mgN/L.

31. The method of claim 17 wherein the second predetermined threshold value S2 ranges from 0.01 μgN-HNO₂/L to 20 μgN-HNO₂/L.

32. The method of claim 17 wherein the third threshold value S3 ranges from 0 mgN-NO₂/L to 120 mgN-NO₂/L.
